(19) United States
(12) Patent Application Publication
(10) Pub. No.: US 2016/0248246 A1
(43) Pub. Date: Aug. 25, 2016

(54) DETECTING FAULTS IN ELECTRICITY GRIDS

(71) Applicant: VESTAS WIND SYSTEMS A/S, Aarhus N (DK)

(72) Inventors: Lars HELLE, Suldrup (DK); Remus TEODORESCU, Aalborg (DK)

(73) Assignees: VESTAS WIND SYSTEMS A/S, Aarhus N (DK); VESTAS WIND SYSTEMS A/S, Aarhus N (DK)

(21) Appl. No.: 15/026,181

(22) PCT Filed: Sep. 17, 2014
(86) PCT No.: PCT/DK2014/050289

§ 371 Date: Mar. 30, 2016

(30) Foreign Application Priority Data
Sep. 30, 2013 (DK) PA 2013 70540

(51) Int. Cl. H02H 7/26; H02M 5/458; F03D 9/00; H02H 3/08; H02H 3/24

(52) U.S. Cl. CPC H02H 7/26; H02H 3/083; H02H 3/24; F03D 9/003; H02M 5/458

(57) ABSTRACT

A wind turbine generator 1 is connected to a section 2 of an electricity grid 3 via a converter 4, which converts the ac output power from the generator into three-phase electric power at the voltage and frequency of the grid 3. The converter 4 comprises silicon carbide transistors which act as ON-OFF switches which are controlled so as to create a voltage profile which is the same as that of the grid voltage. Each grid section 2, 2′ has a respective circuit breaker 10, 10′ which disconnects the associated section from the remainder of the grid 3 in the event of an abnormally high current. The converter 2 includes a fault detector 11 arranged to detect grid faults, such as an abnormally low voltage level which, in response, generates an alarm signal which causes a high-level transient current to be supplied to the grid 3 sufficient to trip the circuit breaker 10′ so as to disconnect the faulty section of the grid. By using silicon carbide transistors, which can withstand high operating temperatures, a higher-level current can be generated than would be the case with converters using conventional silicon transistors.

The present invention relates to electricity grids, and in particular to systems and methods for disconnecting portions of electricity grids in the event of an electrical fault.

At present, in the event of a fault occurring in a portion of a mains electricity power grid, the fault can affect neighbouring parts of the grid. For example, in the case of a voltage drop within a section of the grid, the voltage of the adjacent parts of the grid would also tend to drop, which could have an adverse effect on any equipment which draws power from the grid.

Electricity grids are typically provided with circuit breakers which act as safety devices and which are arranged to disconnect any portion of the grid in which the electric current exceeds a given level.

Wind turbine generators which are connected to an electricity grid are conventionally provided with means for generating additional current in the event of a temporary voltage drop in the grid, so as to maintain the connection to the grid. This maintained connection is termed “low-voltage ride-through”. Such temporary voltage drops may have a duration of the order of 100 ms. The magnitude of the additional current is typically proportional to the voltage drop. The current is usually reactive current, i.e. current which is shifted by 90° relative to the grid voltage, so as to avoid power transfer from the wind turbine generator into the grid.

Most commercial wind turbine generators are arranged to operate at variable speed, which means that the generator voltage and frequency of the generated current will in general be different from that of the mains electricity grid.

In order for the power to be transferred from such wind turbine generators to the grid, it is therefore necessary for both the voltage level and the frequency of the output current of the generator to be converted to the voltage level and the frequency of the grid. This is typically achieved using a two-stage converter, in which the variable-frequency output is first converted to a dc current, and subsequently re-converted to the voltage and frequency of the electricity grid.

Such converters typically comprise an array of silicon transistors which act as switches, and the desired output voltage profile is generated by the use of pulse-width modulation (PWM).

The use of silicon carbide transistors in such converters has been suggested, since such transistors have significant technological advantages over conventional silicon transistors.

Thus, silicon carbide transistors have significantly reduced switching losses, substantially better voltage-blocking capability (i.e. when in the OFF or non-conductive state) and can operate at much higher temperatures, as compared with silicon transistors.

In the event of a fault in a portion of an electric grid, such as a voltage drop, it would be desirable to provide a system which is able to disconnect that portion of the grid from the neighbouring portions of the grid automatically.

Furthermore, in the event of a fault in a portion of an electric grid, such as a voltage drop, it would be desirable to provide a system which is able to supply (or partly supply) the excessive current needed to trigger the automatic disconnect-action of the faulty portion of the grid.

Thus, in accordance with a first aspect of the present invention there is provided a system for disconnecting a section of an electricity grid in the event of a fault occurring in the section, the section being provided with a circuit breaker arranged to disconnect the grid section when the current in the section exceeds a predetermined value, the system comprising: means, e.g. at least one detector, for detecting the occurrence of a fault in the section of the electric grid; and means, e.g. at least one electrical supply or electric current-generating/supplying equipment, acting in response thereto for supplying the grid section with an electric current which exceeds the predetermined value, thereby causing the circuit breaker to disconnect the grid section.

A major commercial advantage of such an arrangement is that the transmission system operator, or grid controller, can readily be alerted to the fault by the operation of the circuit breaker, and it is envisaged that payment could be made by the grid controller to the wind turbine generator operator for each occurrence of a grid fault which is notified to the grid controller in this way.

The supplying means is preferably arranged to supply a reactive current, since this can achieve the desired disconnection of the grid section without requiring the generation of any power.

Alternatively, or in addition, the supplying means may be arranged to supply an active current, in which case the power can be derived from the turbine, from a battery or from other suitable source.

In either case, the current is generated for only a sufficient time to cause the circuit breaker to trip the current within the grid section.

In the preferred embodiment, the system is arranged within a wind turbine generator, since such generators are typically already equipped with means for detecting both the voltage and frequency of the grid voltage and can therefore determine the occurrence of a fault on the grid.

The wind turbine generator is preferably provided with a converter for converting the frequency and/or voltage of the output of the wind turbine generator to the frequency and/or voltage of the electricity grid.

In this, case the converter may be arranged to generate the current which is supplied by the supplying means.

In general, prior art circuit breakers in the grid work in the way that they react to a certain level of the current running through them, e.g. a current level somewhat higher than nominal grid current. In an electricity grid with a high penetration of wind turbine generators (WTGs) having full-scale converters, the short circuit current which will trip the grid circuit breakers may be quite low because converter-controlled WTGs are, in general, controlling the current immediately and do not allow the WTG to supply more than nominal WTG current (as a higher current could potentially damage the converter). By using converter elements that are more robust against transient overloading, the converter (and the converter elements) may be able to feed the transient overcurrent needed to trip the grid circuit breakers. The converter elements may be silicon carbide transistors, e.g., as further disclosed hereinafter.

The converter preferably comprises transistors which are made from silicon carbide. As described above, such silicon carbide transistors offer significant advantages over conventional silicon transistors, especially when used in such converters.

Silicon carbide transistors can withstand substantially higher operating temperatures than conventional silicon transistors, which means that they are particularly suited to a system which is arranged to generate abnormally high currents during rarely occurring events. Thus, silicon carbide transistors can safely operate at elevated temperatures of between 400° C. and 500° C. without significant losses. If conventional silicon transistors were to be used, which can withstand only lower temperatures, such an arrangement would require the provision of an additional auxiliary converter, which would add to the expense of the system.

With such a system, the driving and protection circuitry would need to be thermally insulated against such high temperatures, but otherwise the system could readily be retrofitted on to existing systems, simply by replacing converters based on silicon transistor technology with converters comprising silicon carbide transistors.

Silicon carbide transistors can be used to generate reactive currents as high as 4 to 5 pu, as compared with the reactive currents of only 1.2 to 1.5 pu with silicon transistors. In this context, 1 pu is equivalent to the nominal current output of a wind turbine generator. A transient abnormally high current of three times nominal could be generated using silicon carbide transistors.

Silicon carbide transistors also exhibit a much higher voltage-blocking capability than silicon transistors, which means that a higher dc voltage can be used in the converter, which, in turn, enables a higher reactive current to be generated. For a given dc voltage level V within the converter, the maximum line-line output ac voltage is V/√2. Thus, for a dc voltage of 800 volts, the maximum line-line output ac grid voltage is 566 volts.

The switching speed of silicon carbide transistors is also much higher than that of silicon transistors, which enables the desired ac grid voltage profile to be emulated more closely.

The preferred system is particularly advantageous in being able to react to a fault constituting a drop in the grid voltage, since such a fault would not conventionally lead to an automatic disconnection of the grid section using circuit breakers.

In this case, the generated current is preferably proportional to the size of the voltage drop, since this will ensure that the circuit breakers operate to disconnect the faulty grid section.

The present invention extends to a method of disconnecting a section of an electricity grid in the event of a fault occurring in the section, the section being provided with a circuit breaker arranged to disconnect the grid section when the current in the section exceeds a predetermined value, the method comprising: detecting the occurrence of a fault in the section of the electric grid; and, in response thereto, supplying the grid section with an electric current which exceeds the predetermined value, thereby causing the circuit breaker to disconnect the grid section.

A preferred embodiment will now be described with reference to the accompanying drawings, in which:

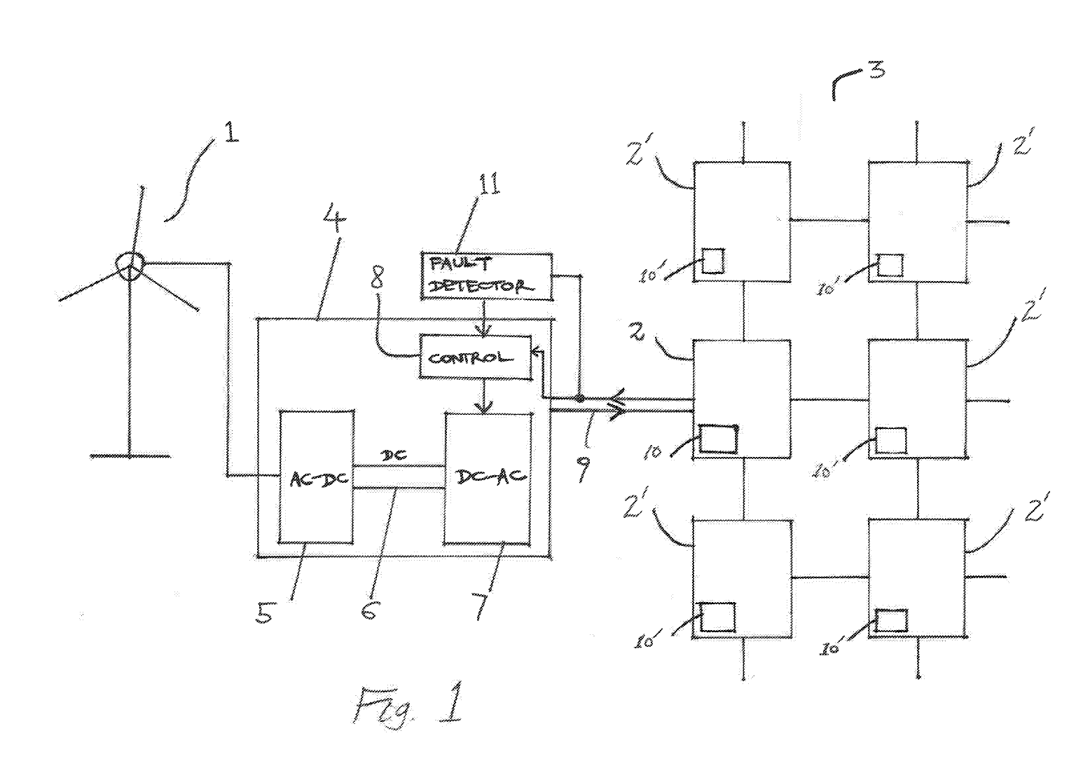

FIG. 1 is a schematic diagram illustrating the system of a preferred embodiment of the present invention; and

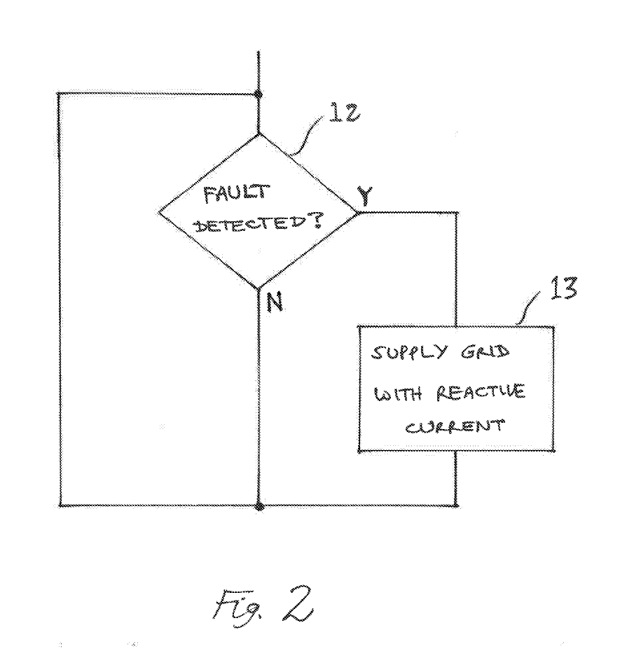

FIG. 2 is a flowchart illustrating a method in accordance with a preferred embodiment of the present invention.

Referring to FIG. 1, a wind turbine generator (WTG) 1 is connected to a portion 2 of a mains electricity grid 3 via a converter 4, which converts the output electrical power from the WTG 1 into electric power at the voltage and frequency of the grid 3. Power is generated in the form of a three-phase supply.

Since the WTG generator 1 operates at a variable speed in dependence on the wind conditions, the voltage and frequency of the generated electric current will also be variable. A first stage of the converter 4 is an ac-dc converter 5 which converts the output power from the WTG 1 into dc current. The dc current is then supplied from the ac-dc converter 5 along conductors 6 to a second stage of the converter 4 which is a dc-ac converter 7. The converter 2 also includes a control module 8 which detects the phase of the ac voltage on the grid voltage and generates suitable control signals to the dc-ac converter so as to ensure that the resulting generated ac voltage is in phase with the grid voltage.

The dc-ac converter 7 comprises an array of silicon carbide transistors (not shown) which act as on-off switches which operate in accordance with control signals supplied to the respective gate electrodes. By adjusting the control signals supplied to the transistors, the desired voltage profile of the output ac voltage is achieved using conventional pulse-width modulation.

In this embodiment, each of the silicon carbide transistors is a 1700 volt/500 amp JFET, and the transistors are encased within thermally insulating housing to prevent damage to the other components within the converter 4.

The output voltage is supplied along cables 9 to the portion 2 of the mains grid 3, which comprises many such portions 2′.

Each grid portion 2, 2′ is provided with a respective circuit breaker 10, 10′ which is arranged to disconnect the associated portion from the remainder of the grid 3 in the event of an abnormally high current, such as could be caused by a short circuit.

The converter 2 also comprises a fault detector 11 which includes a phase-locked loop and which is connected to the portion 2 of the grid 3 associated with the WTG 1, which is arranged to detect faults on the grid portion 2, such as an abnormally low voltage level. In response to the detection of such a fault, the fault detector 11 issues an alarm signal to the control module 8 which, in turn, causes a transient abnormally high current to be supplied to the cables 9, which is sufficient to trip the circuit breaker 10′ of the grid portion 2, thereby to cause the grid portion 2 to become disconnected from the remaining parts of the grid 3. The generated current is a reactive current, i.e. separated in phase from the grid voltage by 90°, such that no power is actually transferred into the grid. This is achieved by applying suitably timed signals to the control electrodes of the silicon carbide transistors. The 90° phase shift is created by feeding the output current through an inductor provided at the output of the converter 4.

The size of the abnormally high reactive current is proportional to the magnitude of the detected voltage drop and is typically above 1 pu, and can be within the range 4 to 5 pu.

By causing the faulty portion 2 of the grid 3 to become disconnected, the voltage drop experienced in that portion 2 no longer adversely affects the neighbouring portions 2′ of the grid 3.

The grid operator can then attend to the fault and, once repaired, can re-set the circuit breaker 10 so as to re-connect the grid portion 2 to the remainder of the grid 3.

Referring to the flowchart of FIG. 2, the simplified method of the preferred embodiment comprises a first step 12 of continuously monitoring the voltage in a portion of the grid for the presence of a fault. In the event of a positive determination of a fault, the grid portion is supplied with an abnormally high reactive current at step 13 in order to cause the circuit breaker within that portion to disconnect the portion from the neighbouring portions of the grid.

Although preferred embodiments of the invention have been described above, it will be appreciated that various modifications may be made without departing from the scope of the invention which is defined by the following claims.

What is claimed is:

1. A system for disconnecting a section of an electricity grid in the event of a fault occurring in the section, the section being provided with a circuit breaker arranged to disconnect the grid section when the current in the section exceeds a predetermined value, the system comprising:
means for detecting the occurrence of a fault in the section of the electric grid; and
means acting in response thereto for supplying the grid section with an electric current which exceeds the predetermined value, thereby causing the circuit breaker to disconnect the grid section.

2. A system as claimed in claim 1, wherein the supplying means is arranged to supply a reactive current.

3. A system as claimed in claim 1, wherein the supplying means is arranged to supply an active current.

4. A system as claimed in claim 1, and arranged within a wind turbine generator.

5. A system as claimed in claim 4, wherein the wind turbine generator is provided with a converter for converting the frequency and/or voltage of the output of the wind turbine generator to the frequency and/or voltage of the electric grid.

6. A system as claimed in claim 5, wherein the converter is arranged to generate the current which is supplied by the supplying means.

7. A system as claimed in claim 5, wherein the converter comprises transistors which are made from silicon carbide.

8. A system as claimed in claim 1, wherein the fault comprises a drop in the grid voltage.

9. A method of disconnecting a section of an electricity grid in the event of a fault occurring in the section, the section being provided with a circuit breaker arranged to disconnect the grid section when the current in the section exceeds a predetermined value, the method comprising:
detecting the occurrence of a fault in the section of the electric grid; and,
in response thereto, supplying the grid section with an electric current which exceeds the predetermined value, thereby causing the circuit breaker to disconnect the grid section.
